(19) United States
(12) Patent Application Publication
(10) Pub. No.: US 2003/0192225 A1
(43) Pub. Date: Oct. 16, 2003

(54) Fishing lure protector device

(76) Inventors: Derek Whitmill, Cairns (AU); Alison Whitmill, Cairns (AU)

Correspondence Address: Renner, Otto, Boisselle & Sklar, LLP, 19th Floor, 1621 Euclid Avenue, Cleveland, OH, 44115, US

(21) Appl. No.: 10/413,902

(22) Filed: Apr. 14, 2003

(30) Foreign Application Priority Data
Apr. 15, 2002 (AU) 34328/02

(51) Int. Cl. A01M 1/00

(52) U.S. Cl. 43/1

(57) ABSTRACT

A fishing lure protector device that comprises a flexible sheet member which is adapted to be folded about the lure, the sheet member having opposed edges, and attachment means to allow the opposed edges to be attached relative to each other to protect the lure and to immobilise the hooks.

### FIELD OF THE INVENTION

This invention is directed to a fishing lure protector device which holds and protects a fishing lure against damage to the fishing lure and injury to the person handling the fishing lure. The invention is particularly directed towards immobilization of hooks that prevents tangling, and promotes safe storage.

### BACKGROUND ART

Fishing lures typically comprise a lure body which may be fish shaped, brightly coloured and the like. A fish hook is attached to the lure body. The fish hook is typically attached via an eyelet which means that the hook can swing freely relative to the lure body.

It is known for larger lures to have two, three or even more fish hooks attached to the lure body at spaced apart intervals. It is also known for each hook to be a double barbed or triple barbed hook.

Thus, these lures are quite difficult to handle and the multitude of sharp fish hooks can easily injure the person handling the lure. Moreover, storage of these lures is troublesome as the lures very quickly catch each other and become difficult to separate. Some lures are quite delicate and are damaged during rough handling.

It is known to provide a pouch or a plurality of pouches with a fishing lure being placed within each pouch. However it is still found that retrieval of the lures from the pouches can be troublesome as the hooks can catch in the pouch.

### OBJECT OF THE INVENTION

It is an object of the invention to provide a device which can hold fishing lures quite safely and which can protect the fishing lures against damage. It is a further object of the invention to provide a device which may overcome at least some of the above mentioned disadvantages or provide the consumer with a useful or commercial choice.

In one form the invention resides in a fishing lure protector device for a fishing lure having a body portion and at least one hook, the protector device comprising a flexible sheet member which is adapted to be folded about the lure body portion, the sheet member having opposed edges, and attachment means to allow the opposed edges to be attached relative to each other to protect the lure, wherein at least one of the hooks of the fishing lure is secured between the attachment means.

In this manner, the lure can be protected by being placed within the flexible sheet member. The flexible sheet member can be folded about the lure to protect the lure and the hooks. However the sheet member can be opened up and therefore does not comprise a permanent pouch which can have disadvantages.

The flexible sheet member can comprise various different sizes depending upon the size and shape of the lure. For instance, lures can have a length of between 30-200 mm and therefore the size of the flexible sheet member can vary to suit. Suitably, the flexible sheet member is sized such that it will protect a major part of the lure although it is envisaged that a forward part or another part of the lure may project from the sheet member. It is preferred however that the protector device protects and/or holds in place at least the hooks of the lure.

The shape of the flexible sheet member can vary. It is preferred that the flexible sheet member is substantially rectangular when viewed in plan and that it can be folded to form a temporary sleeve to protect the lure.

A typical sheet member can have a length of between 30-l200 mm, and a width of between 40-150 mm.

The flexible sheet member is preferably formed of a material which is relatively pliant thereby allowing it to be folded into a sleeve, and resistant to salt water, fresh water and the like. It is preferred that the flexible sheet member is formed of a plastics material and preferably of a substantially clear plastics material such that the position of the lure and the hooks can be viewed and selected through the flexible sheet member. The sheet member may have a thickness of between 0.5-5 mm.

While it is preferred that the sheet member is substantially rectangular, it may also be oval or have other polygonal shapes depending inter alia on the type of lure which is to be protected.

The sheet member typically has opposed edges and when the sheet member is folded about the lure, it is preferred that the opposed edges move towards each other. It is especially preferred that the opposed edges contact each other or are closely spaced from each other when the flexible sheet member is folded about the lure.

The device has an attachment means to allow the opposed edges to be attached relative to each other. Various types of attachment means are envisaged. It is preferred that the attachment means is of the type that allows the folded sheet member to be opened back into the initial substantially flat position in a relatively convenient manner. Thus, it is envisaged that the attachment means may comprise hook and loop fastening devices of which VELCRO™ is an example. Thus, it is envisaged that one edge may comprise the hook portion of the fastener and the other edge may comprise the loop portion of the fastener. The hook and loop fastener may comprise strips of material which may be continuous or discontinuous, discreet zones of material, buttons of material and the like. The length and width can vary according to the size of the lure and the hooks. The hook and loop fastener material can be attached to the sheet member by various techniques which can include stitching, gluing, heat welding, RF welding, and the like.

It is also envisaged that the attachment means may comprise mechanical fasteners such as studs. The studs may include press studs having a male portion on one edge and a corresponding female portion on the other edge. The male portions may all extend along one edge and the female portions may all extend along the other edge or the male and female portions may be on both edges. It is also envisaged that the attachment means may comprise a catch, a hook and eyelet arrangement and the like. Other attachment means may comprise a zip type arrangement, and a press lock type arrangement an example of which may comprise an elongate rib adjacent one edge which presses into a elongate recess adjacent the other edge.

Suitably, the device includes a further attachment means to allow the device to be attached to a holder and preferably be releasably attached to the holder.

The holder may comprise a backing member to which the device can be attached. Typically, a plurality of such devices can be attached to the backing member which means that a plurality of lures can be held to the holder. Again, the type of further attachment means may vary as described above but it is considered expedient to use a hook and loop type system with one part of the hook and loop system forming the further attachment means, and the other part of the hook and loop system forming part of the holder and typically being attached to the backing member.

The holder may comprise a flexible member. The flexible member may comprise a canvas, a cloth, a plastics material, composite materials and the like.

In another form, the invention resides in a holder for holding a plurality of fishing lures, each fishing lure having a body portion and at least one hook, the holder comprising a plurality of lure protector devices, at least some of the devices comprising a flexible sheet member adapted to be folded about the lure body portion, the sheet member having opposed edges, and attachment means to allow the opposed edges to be attached relative to each other to protect the lure, wherein at least one of the hooks of the fishing lure is secured between the attachment means and a further attachment means to allow the device to be releasably attached to the holder, the holder comprising a backing member to which the devices can be releasably attached.

The holder may include a belt member and the like to allow the holder to be mounted to the person's waist. Alternatively, the holder can be simply rolled and held in place by a tie or flexible line member, a strap ribbon and the like.

Alternatively, the holder may be provided with hooks, catches, buckles, or other type of attachment means or members to allow the holder to be attached to or supported by the person, parts of the person's clothing, parts of the person's tackle, equipment etc.

The holder may also have a portion adapted to allow the attachment or association of advertising material to the holder, for example a trade mark or logo.

### BRIEF DESCRIPTION OF THE DRAWINGS

An embodiment of the invention will be described with reference to the following representations in which:

FIG. 1 illustrates a device in the open position.

FIG. 2 shows a lure being placed onto the device of FIG. 1.

FIG. 3 shows the device being folded about the lure.

FIG. 4 shows the lure protected by the device.

FIG. 5 illustrates opening of the device to free the lure.

FIG. 6 illustrates a holder for holding a plurality of fishing lures and which includes a waist belt.

FIG. 7 shows the holder of FIG. 6 in the partially open position.

FIG. 8 shows the holder of FIG. 6 in the fully open position and exposing the lures for use.

### BEST MODE

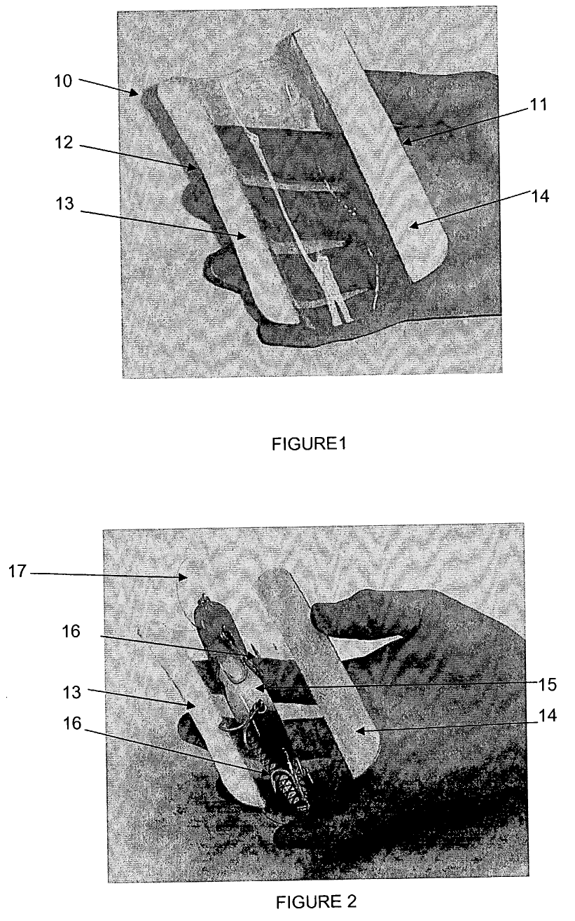

Referring to the drawings and initially to FIG. 1 there is illustrated a fishing lure protector device 10. Device 10 comprises a flexible sheet of clear plastic that in the embodiment has a length of 120 mm and a width of 110 mm. The clear plastic sheet member has a thickness of slightly less than 1 mm. It will of course be appreciated that the size of the sheet member will vary depending on the type of lure that is to be protected. Device 10 has a pair of opposed edges 11, 12 and each opposed edge is formed with an attachment means. In the particular embodiment, the attachment means comprises a hook and loop fastener comprising a strip of loop material 13 stitched to one edge of the flexible sheet member, and a strip of hook material 14 stitched to the other edge of the flexible sheet member. Each strip has a length that is the same as the length of the flexible sheet member and a width of approximately 20 mm. It can thus be seen that flexible sheet member can be folded such that the hook and loop portions attach together to form a temporary sleeve.

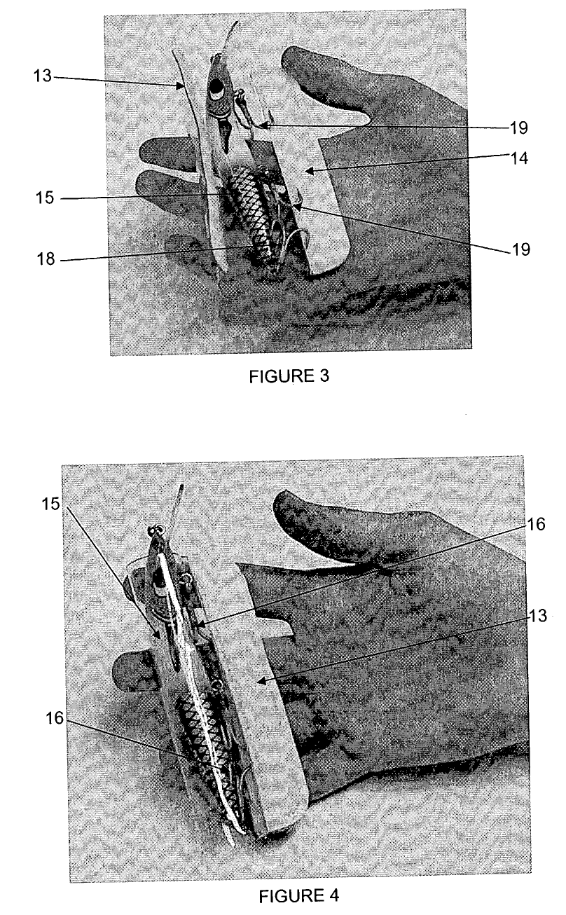

Referring to FIG. 2 there is illustrated a particular known type of lure 15. Lure 15 is placed into the middle section of the flexible sheet member using one hand and the other hand can then be used to fold the flexible sheet member about the lure. FIG. 3 illustrates the folding process where the sheet member is partially folded about lure 15.

Referring to FIG. 4, there is illustrated a device in the “protecting” position where lure 15 is trapped within a sleeve formed by folding and attaching the flexible sheet member. It can be seen that the sharp hooks 16 are now protected and immobilised and cannot accidentally prick the user and cannot snag against another lure.

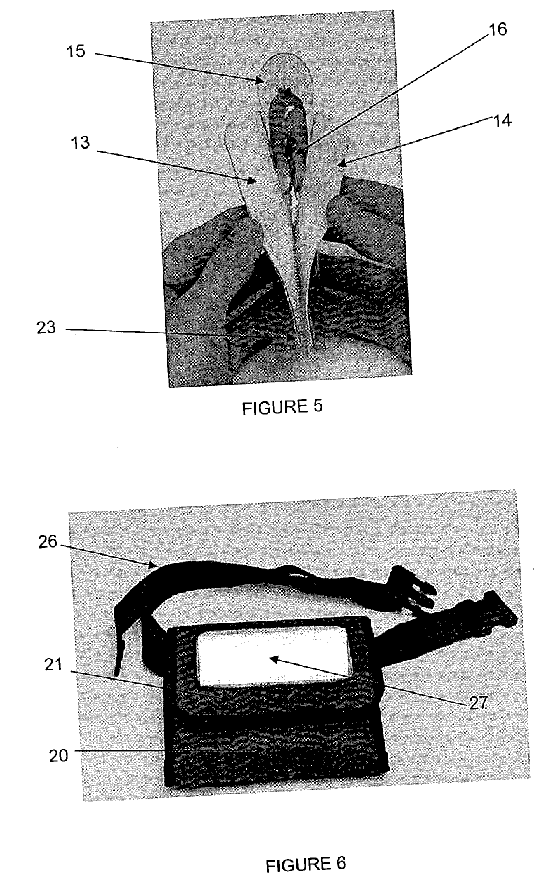

Referring to FIG. 5, this shows the technique to release lure 15. In the technique, the person carefully separates the hook and loop fastening system to release the lure but there can be seen there is little possibility of the sharp hooks injuring the person.

Referring now in greater detail to the use of the devices, initially, the plastic lure protector is placed open in the palm of the person's hand with one of the hook and loop strips above the thumb and the other strip at the tip of the person's finger (refer to FIG. 1). The lure is held by the bib 17 (see FIG. 2) with one hand and is placed into the middle of the flexible sheet member between the hook and loop strips. The sharp hooks 16 face upwardly as illustrated in FIG. 2. If necessary, the lower most hook 18 (see FIG. 3) is folded upwardly into the main body of the flexible sheet member and the hook and loop fastening portions 13, 14 are brought together.

A further advantage of the invention using the hook and loop system can now be seen in that with this arrangement, one of the hooks (19) of each triple hook assembly is placed over the hook part of the hook and loop fastener such that when the sleeve is fastened together hook 19 is trapped between the hook and loop fastening system. This secures and immobilises the hooks. If the lure is smaller than the length of the flexible sheet member or does not have a lower most hook 18, this hook will not need to be folded back into the flexible sheet member. Referring to FIG. 4 it can be seen that each of the triple hooks is now firmly secured by having one of the hook members 19 sandwiched between the hook portion and the loop portion of the fastening system.

To remove the lure, the hook and loop fastening strips are pulled apart starting from the top of the lure (see FIG. 5) and there is very little likelihood of the sharp hooks damaging the user.

Referring to FIG. 6-8 there is shown a holder which can hold a plurality of devices as described with reference to FIGS. 1-5. In the particular embodiment, the holder comprises a elongate substantially rectangular flexible backing member 20 which is best illustrated in FIG. 8. Backing member 20 is provided with a top flap portion 21. Backing member 20 has a long relatively wide VELCRO™ portion 22 (best illustrated in FIG. 8) which is stitched or otherwise attached to one side of the backing member.

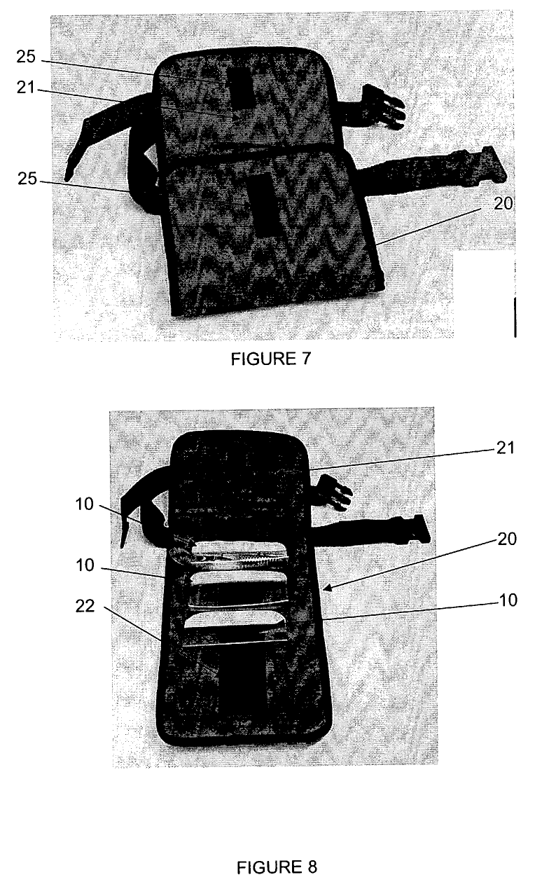

Each device as illustrated in FIGS. 1-5 is provided with a VELCRO™ portion which is in addition to portions 13, 14 and which allows the device to be attached to VELCRO™ portion 22. This addition of VELCRO™ portion is illustrated in FIG. 5 as reference number 23 and is stitched or otherwise attached to the other side of portion 14. Thus, each lure protector device as illustrated in FIGS. 1-5 can be simply press fitted to backing member 20. In FIG. 8 there is illustrated three lures each being protected in their own device with each device being attached to backing member 20. When a lure is required, it can be simply pulled off the backing member and the protecting device can be opened up in the manner illustrated in FIG. 5 to remove the lure 15. Once the lure has been removed, the (empty) backing device can be pushed back onto backing member 20 to stop it from getting lost. The holder can be rolled up in the manner illustrated in FIG. 6 to show the flap member 21 holding the backing member 20 in place. Flap member 21 can be pulled open as illustrated in FIG. 7 that will now allow the backing member 20 to fall downwardly to expose the lures and as illustrated in FIG. 8. An attachment means which, in the embodiment, is another VELCRO™ strip 25 holds the flap member 21 in place against backing member 20. The particular holder illustrated in FIG. 6-8 includes a belt member 26 to allow it to be mounted to a persons waist. However it is also envisaged that a shoulder strap or any other type of attachment can also be used. For instance, the holder may simply be rolled up and held in place by a ribbon or strap.

The lure protector can function to secure the hooks (in the embodiment by having the hooks trapped between the VELCRO™ strips) to protect people or other objects from being pierced or hooked by the lure and to prevent the hooks from tangling with each other.

The flexible sheet member can be made of a clear ultraviolet stabilised vinyl plastic.

The holder may contain additional pouches etc for fishing tools such as pliers etc.

The holder may also have a portion 27 adapted to allow the attachment or association of advertising material to the holder, for example a trade mark or logo.

1. A fishing lure protector device for a fishing lure having a body portion and at least one hook, the protector device comprising a flexible sheet member which is adapted to be folded about the lure body portion, the sheet member having opposed edges, and attachment means to allow the opposed edges to be attached relative to each other to protect the lure, wherein at least one of the hooks of the fishing lure is secured between the attachment means.

2. The device as claimed in claim 1, wherein the sheet member is substantially rectangular when viewed in plan.

3. The device as claimed in claim 1, wherein the sheet member has a length of between 30-200 mm, and a width of between 40-150 mm.

4. The device as claimed in claim 1, wherein the sheet member is substantially transparent.

5. The device as claimed in claim 1, wherein the sheet member is made of a vinyl plastic.

6. The device as claimed in claim 1, wherein the sheet member has a thickness of between 0.5-5 mm.

7. The device as claimed in claim 1, wherein the attachment means is of the type that allows the folded sheet member to be opened back into the initial substantially flat position in a relatively convenient manner.

8. The device as claimed in claim 1, wherein the attachment means comprises a hook and loop fastening device.

9. The device as claimed in claim 8, wherein one opposed edge comprises the hook portion of the fastener and the other opposed edge comprises the loop portion of the fastener.

10. The device as claimed in claimed 9, wherein the hook and loop fastener comprises strips of material.

11. The device as claimed in claim 1, including a further attachment means to allow the device to be attached to a holder.

12. The device as claimed in claim 11, wherein the further attachment means comprises one part of a hook and loop fastening system.

13. The device as claimed in claim 11, wherein the holder has a backing member to which the device can be attached.

14. The device as claimed in claim 13, wherein a plurality of such devices are attached to the backing member which means that a plurality of lures can be held to the holder.

15. The device as claimed in claims 13, wherein the backing member is provided with the other part of a hook and loop fastening system, with respect to the part which comprises the further attachment means.

16. The device as claimed in claim 11, wherein the holder comprises a flexible member.

17. A holder for holding a plurality of fishing lures, each fishing lure having a body portion and at least one hook, the holder comprising a plurality of lure protector devices, at least some of the devices comprising a flexible sheet member adapted to be folded about the lure body portion, the sheet member having opposed edges, and attachment means to allow the opposed edges to be attached relative to each other to protect the lure, wherein at least one of the hooks of the fishing lure is secured between the attachment means and a further attachment means to allow the device to be releasably attached to the holder, the holder comprising a backing member to which the devices can be releasably attached.

18. The holder as claimed in claim 17, including a mounting means to allow the holder to be mounted to or relative to a person.

19. The holder as claimed in claim 18, wherein the mounting means comprises a belt.

20. The holder as claimed in claim 19, wherein the mounting means comprises a shoulder strap.
